(19) United States
(12) Patent Application Publication
(10) Pub. No.: US 2008/0158640 A1
(43) Pub. Date: Jul. 3, 2008

(54) OPTICAL APPARATUS UTILIZING MODULATION BASED ON A TERTIARY DRIVE SIGNAL, OPTICAL TRANSMITTER, AND OPTICAL TRANSMISSION SYSTEM

(75) Inventors: Manabu WATANABE, Kawasaki (JP); Tomoyuki OTSUKA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/950,103

(22) Filed: Dec. 4, 2007

(30) Foreign Application Priority Data
Dec. 5, 2006 (JP) JP2006-328449

(51) Int. Cl. G02F 1/01

(52) U.S. Cl. 359/239

(57) ABSTRACT

An optical apparatus provided with an optical modulator having an periodic characteristic for input drive signal to output light, and modulating an input light into a signal light based on a tertiary drive signal with a bias level controlled to a level corresponding to a bottom of the periodic characteristic providing a minimum optical output; and a controller controlling the level of the signal light by controlling the amplitude of the a tertiary drive signal based on the monitored level of the signal light.

The present invention claims foreign priority to Japanese application 2006-328449, filed on Dec. 5, 2006, which is incorporated herein by reference in its entirety.

### FIELD OF THE INVENTION

The present embodiments relates to an optical modulating apparatus, an optical transmitter, and an optical transmission system.

In an optical transmission system, there are two main methods used to generate an optical signal. One is a direct modulation method and the other is an external modulation method. In the direct modulation method, an optical signal is generated by modulating an intensity of an output light of a light source, such as a semiconductor laser. In the external modulation method, an optical signal is generated by externally modulating a light outputted from a light source, such as a semiconductor laser. The external modulation has advantage that they are not affected by wavelength chirping of a semiconductor laser and thus has an advantage that long-haul transmission can be made in higher velocity.

FIG. 5 shows a structure of an optical transmission system based on an external modulation method of the related art. As shown in FIG. 5, an optical transmitter 1 of the external modulation method in the related art has a semiconductor laser (CW laser) driven by the laser drive circuit 2 provides an output light of constant intensity to an external modulator 4.

The external modulator 4 is driven with a modulator drive circuit 7. The bias level is controlled with an automatic bias control circuit (ABC circuit) and an externally input signal in accordance with an output light power detected with a power monitor 5. An optical power outputted from the external modulator 4 is adjusted with a variable optical attenuator (VOA) 8 that is externally provided to the optical transmitter 1.

By using the external modulation method, signal lights can be modulated to NRZ (Non Return to Zero) signal or duo-binary signal. The NRZ modulation has been generally used in the related art. The duo-binary modulation has been often discussed in these years and has an advantage that deterioration of signal due to dispersion after long-haul transmission is smaller than NRZ modulation.

FIG. 6 shows a diagram for explaining a relationship between a drive signal of the external modulator and an output light power in the NRZ modulation. In FIG. 6, 11 denotes a waveform of a drive signal inputted to an external modulator, while the 12 denotes a waveform of a signal light outputted from the external modulator, and the 13 denotes a bias level of the external modulator.

In the NRZ modulation, as shown in FIG. 6, as the external modulator has a periodic characteristics for the input drive signal to output light a bias level of the external modulator is controlled so that an operating point level of the external modulator is matched with an intermediate point A of a modulator drive signal. The intermediate point A is between the level corresponding to a maximum output light and the level corresponding to a minimum output light. A binary transmitting signal of “0” and “1” is modulated on the bias level thereof.

FIG. 7 is a diagram for explaining a relationship between a drive signal of the external modulator and an output light power in the duo-binary modulation. As shown in FIG. 7, in the duo-binary modulation, a bias level of the external modulator is controlled so that an operating point level of the external modulator is matched with a modulator drive signal corresponding to the minimum output light. A tertiary transmitting signal of “0”, “1”, and “−1” it is modulated on the bias level thereof.

Concerning duo-binary method, as an optical modulating apparatus comprising an optical modulator having a periodic characteristics for a drive signal and output light, a drive signal generator to generate a tertiary drive signal to drive the optical modulator with an amplitude selected between a couple of light emission peaks or bottoms of the level to output light characteristic, a low frequency oscillator to generate the predetermined low frequency signal, a low frequency signal superposing unit to superpose the low frequency signal to the tertiary drive signal in the manner that the low frequency signal element is included in an optical signal outputted from the optical modulator, a photodiode for detecting the low frequency signal element included in the optical signal outputted from the optical modulator, a low frequency signal detecting unit for detecting an operating point variation of the optical modulator on the basis of the low frequency signal detected with the photodiode, and a operating point control unit for controlling the operating point of the optical modulator in accordance with a direction in which the operating point of the optical modulator changes. In addition, it is also known in this optical modulating apparatus that the optical duo-binary modulation is conducted to convert a binary data signal into a tertiary signal and to convert a tertiary signal into an optical signal.

In the optical modulating apparatus of the related art with an external modulator, it is required to add a variable optical attenuator with a control circuit in order to adjust an output light power of an optical transmitter. That means a larger number of components and increased cost for manufacturing. These problems are in common for both NRZ modulation and the duo-binary modulation.

### SUMMARY

According to an aspect of an embodiment, an optical apparatus provided with an optical modulator having an periodic characteristic for input drive signal to output light, and modulating an input light into a signal light based on a tertiary drive signal with a bias level controlled to a level corresponding to a bottom of the periodic characteristic providing a minimum optical output; and a controller controlling the level of the signal light by controlling the amplitude of the a tertiary drive signal based on the monitored level of the signal light.

### DESCRIPTION OF THE DRAWINGS

FIG. 1 is a diagram for explaining the principle of an optical modulating apparatus of the present embodiments.

FIG. 2 is a diagram for explaining a mechanism to provide variable output light powers based on the optical modulating apparatus of the present embodiments.

FIG. 3 is a diagram showing an optical transmission system utilizing an example of an optical modulating apparatus as a preferred embodiment of the present embodiments.

FIG. 4 is a diagram showing an optical transmission system utilizing the other example of the optical modulating apparatus of the preferred embodiment of the present embodiments.

FIG. 5 is a diagram showing a structure of an optical transmitting system utilizing an optical modulating apparatus of the related art.

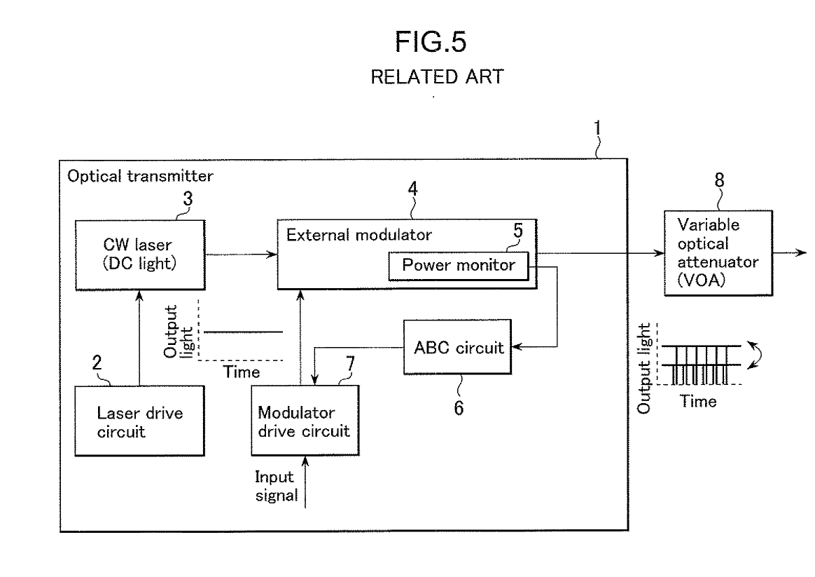

FIG. 6 is a diagram for explaining a relationship between a drive signal of an optical modulating apparatus and an output light power in the NRZ modulation.

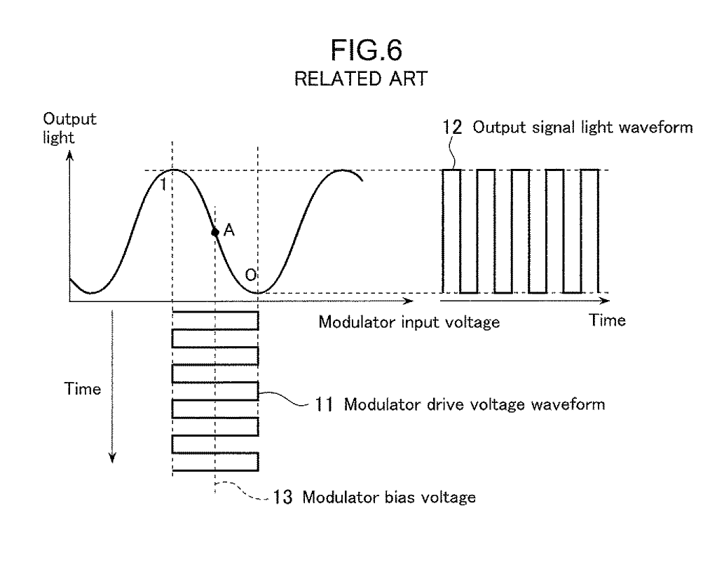

FIG. 7 is a diagram for explaining a relationship between a drive signal of an optical modulating apparatus and an output light power in the duo-binary modulation.

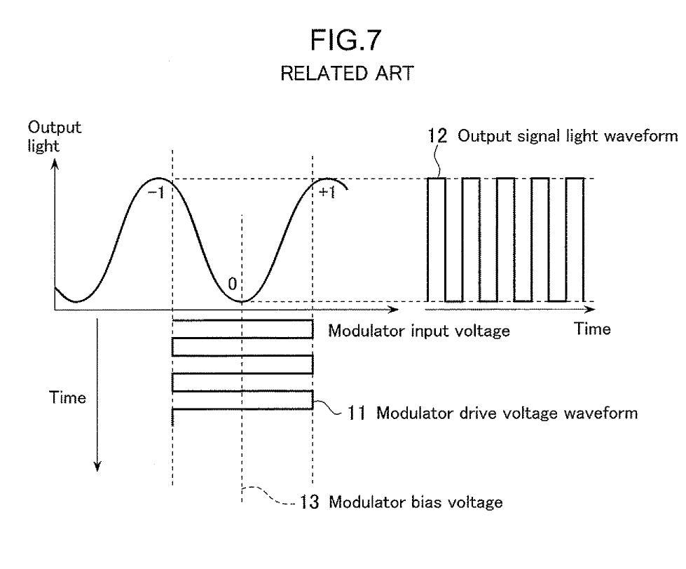

### DESCRIPTION OF THE PREFERRED EMBODIMENTS

The preferred embodiments will be explained in detail with reference to the accompanying drawings.

The identical reference numerals denote the like structures in the following description and the accompanying drawings in view of omitting the duplicated description.

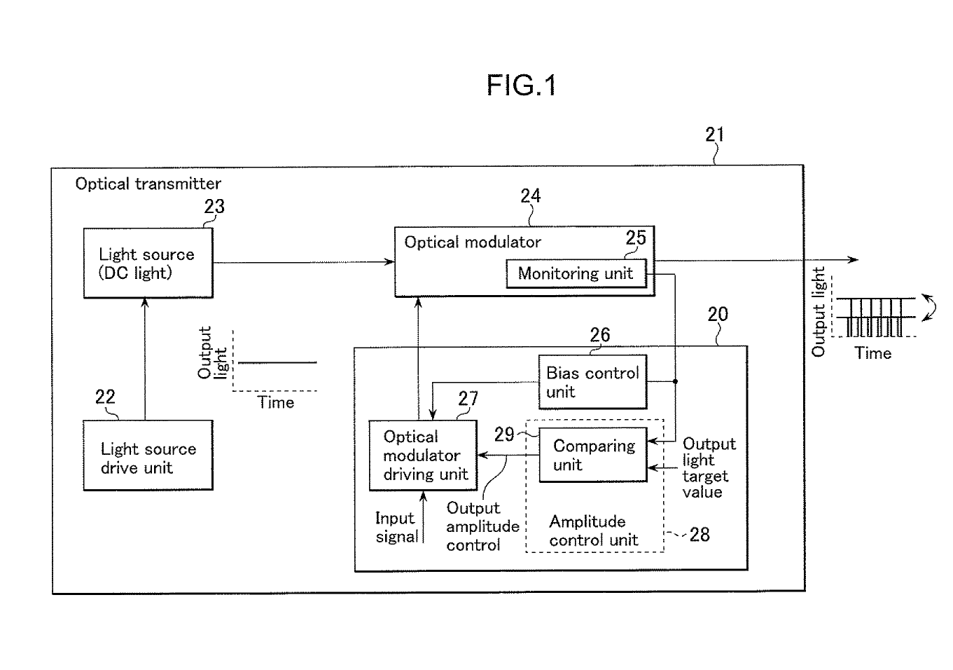

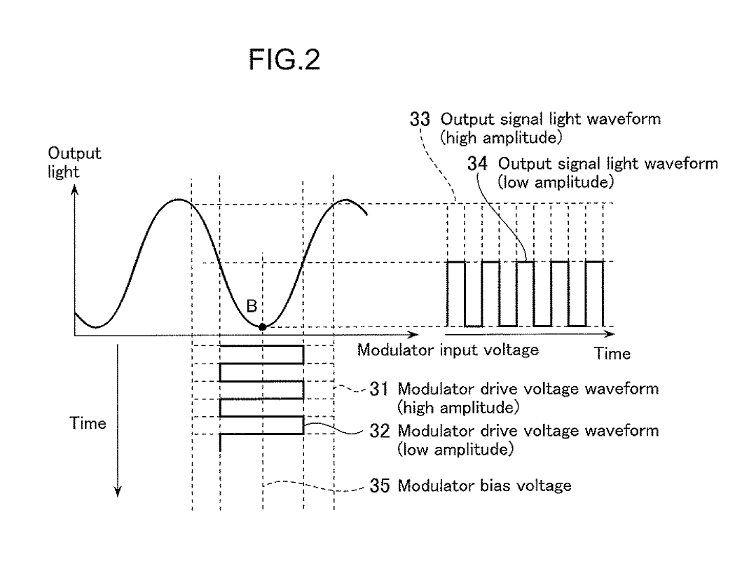

FIG. 1 is a diagram for explaining the principle of the optical modulating apparatus of the present embodiments. FIG. 2 is a diagram for explaining a mechanism for providing variable output light powers on the basis of the optical modulating apparatus of the present embodiments.

As shown in FIG. 1, an optical transmitter 21 includes a light source drive unit (laser drive circuit) 22, and light source (CW laser) 23, an optical modulator (external modulator) 24, a monitoring unit (power monitor) 25, and a controller 20. The controller 20 includes a bias control unit (automatic bias control arithmetic unit) 26, an optical modulator driving unit (modulator drive circuit) 27, and an amplitude control unit 28. The light source drive unit 22 drives the light source 23. The light source 23 continuously outputs the light of constant intensity by driving the light source drive unit 22. The optical modulator 24 has periodic characteristics for an input level to output light, as shown in FIG. 2, and modulates the light outputted from the light source 23.

The monitoring unit 25 detects power of optical signal outputted from the optical modulator 24. The bias control unit 26 controls a bias level of the optical modulator 24 in the manner that an operating point level of the optical modulator 24 is matched with a bottom B (refer to FIG. 2) providing the minimum output light in the input drive signal to output light characteristic. The optical modulator driving unit 27 generates a tertiary drive signal to drive the optical modulator 24 with an amplitude selected between a couple of peaks providing the maximum output light in the input drive signal to output light characteristic on the basis of a input signal inputted from an external side (refer to FIG. 2).

The amplitude control unit 28 includes a comparing unit (differential amplifier) 29. The comparing unit 29 compares an optical signal power (amplitude) detected with the monitoring unit 25 with a target value thereof (output light target value). The amplitude control unit 28 controls an amplitude of a drive signal outputted from the optical modulator driving unit 27 on the basis of the comparison result of the comparing unit 29 in the manner that an optical signal power outputted from the optical modulator 24 is matched with the output light target value.

In FIGS. 2, 31 and 32 denote waveforms of the drive signals, when amplitude is large and small, inputted to the optical modulator 24. 33 and 34 denote waveforms of optical signals, when amplitude is large and small, of the optical signals outputted from the optical modulator 24. 35 denotes a bias level of the optical modulator 24.

According to the present embodiments, an output light power of the optical modulator is matched with an output light target value by comparing an output light power of the optical modulator with the output light target value with the comparing unit and then controlling an output drive signal of the optical modulator driving unit to drive the optical modulator in order to achieve matching of above output light power and the target value Accordingly, the variable optical attenuator for providing variable amplitude of output lights and a control circuit for such variable optical attenuator are no longer required.

According to the optical modulating apparatus of the present embodiments, it is possible to obtain an optical modulating apparatus having a function to provide variable output light powers, because the apparatus outputs an optical signal power matched with the output light target value.

Moreover, according to the optical transmitter and the optical transmission system of the present embodiments, manufacturing cost may be reduced and the optical transmitter may be reduced in size, because the variable optical attenuator and the control circuit thereof are no longer required by utilizing the optical modulating apparatus provided with the function to provide variable output light powers.

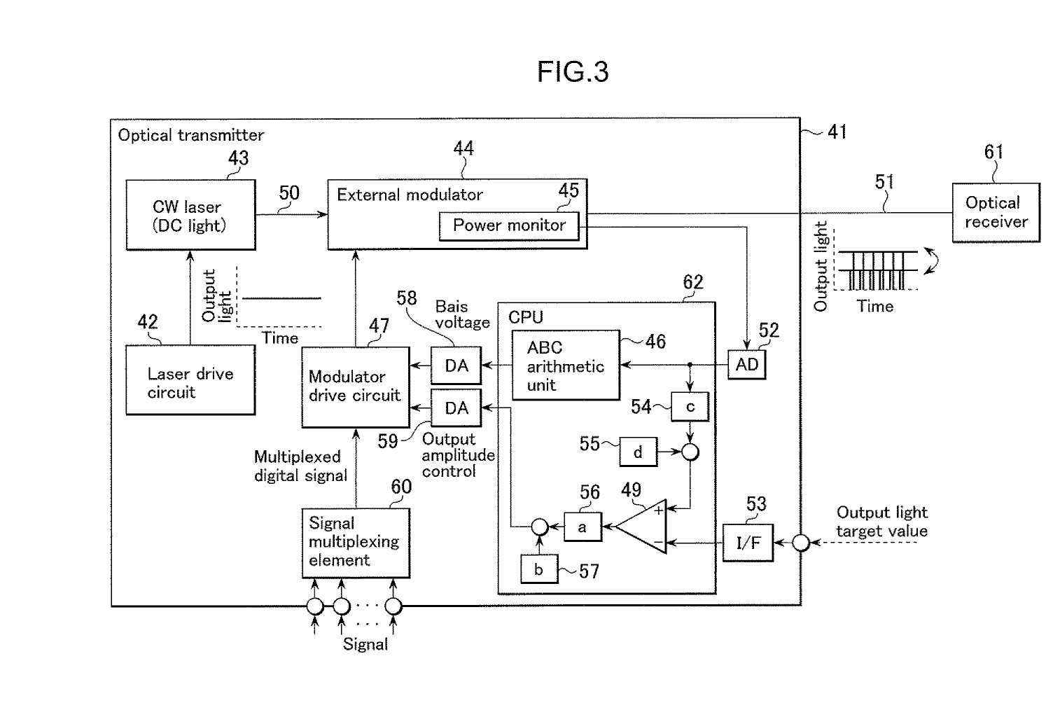

FIG. 3 is a diagram showing an optical transmission system utilizing an example of an optical modulating apparatus as an embodiment of the present embodiments. As shown in FIG. 3, the optical transmission system includes an optical transmitter 41, an optical receiver 61, and an optical transmission line 51 formed of an optical fiber or the like disposed between the optical transmitter 41 and the optical receiver 61.

The optical transmitter 41 is respectively provided with a laser drive circuit 42, a CW laser 43, an external modulator 44 formed, for example, of lithium niobate (LiNbO₃) or the like, a power monitor 45, an automatic bias control arithmetic unit (ABC arithmetic unit) 46, and a modulator drive circuit 47 as the light source drive unit, light source, optical modulator, monitoring unit, bias control unit, and optical modulator driving unit. An input end of the external modulator 44 is connected to the CW laser 43 via an optical transmission line 50 formed of an optical fiber or the like. An output end of the external modulator 44 is connected to the optical transmission line 51. The power monitor 45 is built in the external modulator 44.

The optical transmitter 41 also includes, as an amplitude control unit, a differential amplifier 49 having a comparing unit, a first multiplier 54 for multiplying the predetermined coefficient c, a first adder 55 for adding the predetermined value d, a second multiplier 56 for multiplying the predetermined coefficient a, and a second adder 57 for adding the predetermined value b. These differential amplifier 49, multipliers 54, 56, adders 55, 57, and automatic bias control arithmetic unit 46 can be realized with a hardware having an arithmetic processor for automatic bias control (CPU and DSP) 62 and by executing a software with such arithmetic processor 62.

Moreover, the optical transmitter 41 is provided with an interface (I/F) 53 for external side such as I2C and a signal multiplexing element 60 for multiplexing a digital signal inputted from the external side as the input signal. In addition, the optical transmitter 41 is further provided with an analog to digital converting circuit (A/D) 52, a first digital to analog converting circuit (D/A) 58, and a second digital to analog converting circuit (D/A) 59.

Next, the mechanism for variable output light powers in the optical transmitter 41 will be explained. The CW laser 43 is driven with the laser drive circuit 42 to output a continuous light of constant intensity (DC light) through continuous oscillation. The modulator drive circuit 47 drives the external modulator 44 on the basis of the digital signal multiplexed with the signal multiplexing element 60. Therefore, an output light of the CW laser 43 is modulated.

The power monitor 45 outputs an output light monitor signal by detecting the modulated optical signal power. The analog to digital converting circuit 52 converts the output light monitor signal of analog value to a digital value. The first multiplier 54 and the first adder 55 multiply the predetermined coefficient c to an output value of the analog to digital converting circuit 52 and moreover add d to the value obtained by multiplication. This arithmetic operation converts the monitor value of the power monitor 45 to an optical power and an output light power can be obtained with this arithmetic operation.

The differential amplifier 49 compares the output light power obtained by arithmetic operation with an output light target value to output a difference between the present output light power and the target power. The output light target value is set from the external side via the interface 53. The second multiplier 56 and the second adder 57 multiply the predetermined coefficient a to an output value of the differential amplifier 49 and further adds the predetermined value b to the value obtained by multiplication.

The second digital to analog converting circuit 59 converts the value obtained by multiplication of a and addition of b into an analog signal and supplies this analog signal to the modulator drive circuit 47 as an output amplitude control signal. The modulator drive circuit 47 determines modulation amplitude of a digital signal inputted to the optical transmitter 41 from the external side on the basis of an output amplitude control signal supplied from the second digital to analog converting circuit 59. Here, the coefficient a is a negative value. Accordingly, an output value of the second multiplier 56 takes a positive value when the present output light power is smaller than the target power and has a negative value in the contrary case.

The value of b is adjusted just to the center of variable region of the output light power. Therefore, when the present output light power is smaller than the target power, the output amplitude control signal increases amplitude of the drive signal for providing a larger output light power, namely modulator drive signal outputted from the modulator drive circuit 47. Meanwhile, when the present output light power is larger than the target power, the amplitude may be reduced by output amplitude control signal.

On the other hand, the automatic bias control arithmetic unit 46 outputs a bias control signal on the basis of an output value of the analog to digital converting circuit 52. The first digital to analog converting circuit 58 converts this bias control signal to an analog signal and supplies this analog signal to the modulator drive circuit 47 as a bias level. Thereby, the modulator drive circuit 47 matches the operating point amplitude of the external modulator 44 to the bottom B providing the minimum output light of the input drive signal to output light characteristic shown in FIG. 2.

Here, interference between variable control of output light and automatic bias control must be eliminated to realize stabilization of these controls. Although not particularly restricted, it is enough, for example, amplitude control period by variable control loop of output light is set to 100 times or more than the automatic bias control period.

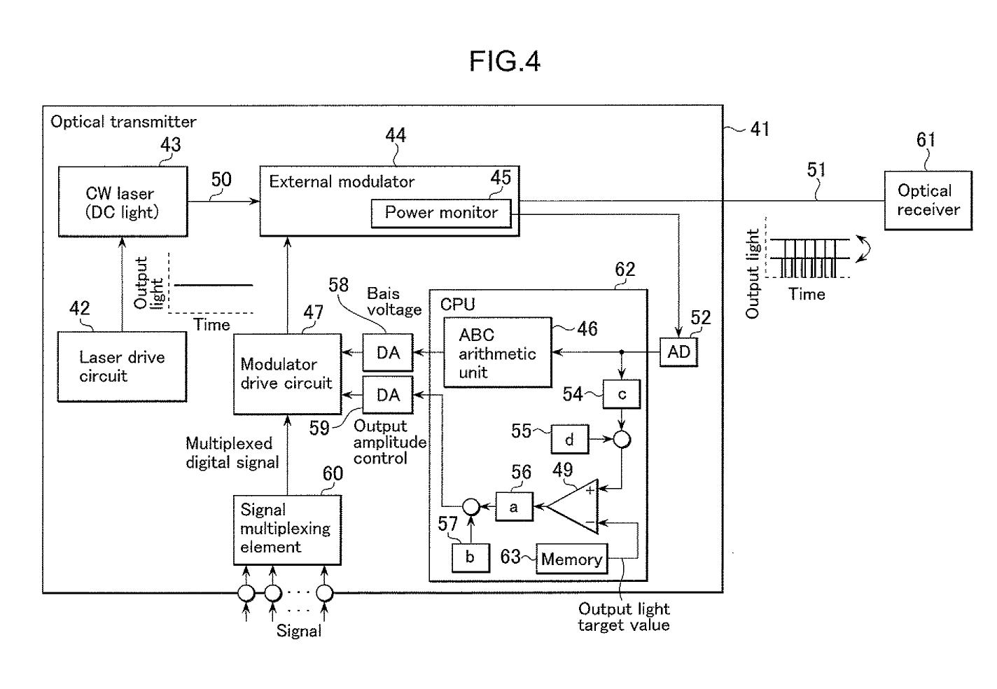

FIG. 4 is a diagram showing an optical transmission system utilizing the other example of the optical modulating apparatus of the embodiment of the present embodiments. The example shown in FIG. 4 is different from the example of FIG. 3 in the point that an output light target value is stored in a memory 63. Therefore, this memory 63 supplies the output light target value to the differential amplifier 49. The other structure is identical to the example shown in FIG. 3.

As explained above, according to this embodiment, an optical modulating apparatus having the function providing variable output light powers can be attained because a difference between the present output light power and the target power is obtained with the differential amplifier 49 and the modulator drive circuit 47 outputs a drive signal of the external modulator 44 for matching the output light power to the target power on the basis of this difference. Therefore, the optical transmitting system utilizing this optical modulating apparatus does not require the variable optical attenuator for providing variable output lights and the control circuit thereof. In addition, the optical transmitter having realized reduction in cost and size may be realized, because output light can be controlled with an arithmetic processor (CPU, or the like) 62 for automatic bias control.

Although, the present embodiments has been described above, but the present embodiments is not restricted only to the embodiment described above and allows variable changes or modifications. For example, the amplitude control unit may be comprised with an analog circuit. In this case, the analog to digital converting circuit 52 and the digital to analog converting circuits 58, 59 are not required.

What is claimed is:

1. An optical apparatus comprising:
an optical modulator having a periodic characteristic for input drive signal to output light, driven by a tertiary drive signal and thereby outputting a signal light based on the periodic characteristic;
a driving unit generating the tertiary drive signal to the optical modulator with a bias level;
an amplitude control unit controlling an amplitude of the tertiary drive signal;
a bias control unit controlling the bias level to a level corresponding to a bottom of the periodic characteristic providing a minimum optical output, and;
a monitoring unit monitoring the level of the signal light, wherein the amplitude control unit controls the amplitude of the drive signal based on the monitored level of the signal light.

2. The optical apparatus according to claim 1, wherein the level of the signal light is controlled by the amplitude control unit.

3. The optical apparatus according to claim 2, wherein the amplitude control unit controls the amplitude of the tertiary signal light based on the monitored level of the signal light and a target value input to the amplitude control unit.

4. The optical apparatus according to claim 3, further comprising a comparing unit comparing the monitored level of the signal light with the target value.

5. The optical modulating apparatus according to claim 4, wherein the amplitude control unit includes a memory for storing the target value.

6. An optical apparatus comprising;
a light source;
an optical modulator having an periodic characteristic for input drive signal to output light, driven by a tertiary drive signal and thereby outputting a signal light based on the periodic characteristic;
a driving unit generating the tertiary drive signal to the optical modulator with a bias level;
an amplitude control unit controlling an amplitude of the tertiary drive signal;
a bias control unit controlling and adjusting the bias level to a level corresponding to a bottom of the periodic characteristic providing a minimum optical output, and;
a monitoring unit monitoring the level of the signal light, wherein
the amplitude control unit controls the amplitude of the drive signal based on the monitored level of the signal light.

7. The optical apparatus according to claim 6, wherein the level of the signal light is controlled by the amplitude control unit.

8. The optical apparatus according to claim 7, wherein the amplitude control unit controls the amplitude of the tertiary signal light based on the monitored level of the signal light and a target value input to the amplitude control unit.

9. The optical apparatus according to claim 8, further comprising a comparing unit comparing the monitored level of the signal light with the target value.

10. The optical modulating apparatus according to claim 8, wherein the amplitude control unit includes a memory for storing the target value.

11. A method comprising:
modulating an input light into a signal light with a optical modulator with an periodic characteristic for input drive signal to output light, based on a tertiary drive signal with a bias level controlled to a level corresponding to the bottom of the periodic characteristic providing the minimum optical output;
controlling the level of the signal light by controlling the amplitude of the tertiary drive signal based on the monitored level of the signal light.

12. An optical apparatus comprising:
an optical modulator having an periodic characteristic for input drive signal to output light, and modulating an input light into a signal light based on a tertiary drive signal with a bias level controlled to a level corresponding to a bottom of the periodic characteristic providing a minimum optical output;
a controller controlling the level of the signal light by controlling the amplitude of the tertiary drive signal based on the monitored level of the signal light.
